(19) United States
(12) Patent Application Publication
(10) Pub. No.: US 2012/0212622 A1
(43) Pub. Date: Aug. 23, 2012

(54) MOVING OBJECT IMAGE TRACKING APPARATUS AND METHOD

(75) Inventors: Hiroaki Nakamura, Kawasaki-shi (JP); Tadashi Kuroiwa, Machida-shi (JP)

(73) Assignee: KABUSHIKI KAISHA TOSHIBA

(21) Appl. No.: 13/224,444

(22) Filed: Sep. 2, 2011

(30) Foreign Application Priority Data
Feb. 17, 2011 (JP) 2011-032086

(51) Int. Cl. H04N 5/225

(52) U.S. Cl. 348/169; 348/E05.024

(57) ABSTRACT

According to one embodiment, a moving object image tracking apparatus includes two drivers, a camera sensor, a tracking error detector, angle sensors, angular velocity sensors, a first calculator, a second calculator, a corrected tracking error detector, a generator, and a controller. The tracking error detector detects tracking errors as deviation amounts of a moving object from a visual field center from the image data as tracking error detection values. The corrected tracking error detector calculates corrected tracking errors for each period shorter than a sampling period, tracking error detection values being constant, from a velocity vector and a relationship between a visual axis vector and a position vector. The generator generates angular velocity command values required to drive the drivers to track the moving object using the corrected tracking errors. The controller controls the drivers so that differences between the angular velocity command values and angular velocities become zero.

### CROSS-REFERENCE TO RELATED APPLICATIONS

This application is based upon and claims the benefit of priority from prior Japanese Patent Application No. 2011-032086, filed Feb. 17, 2011, the entire contents of which are incorporated herein by reference.

### FIELD

Embodiments described herein relate generally to a moving object image tracking apparatus and method for controlling a target recognition sensor such as a camera to track a target which moves in all directions.

### BACKGROUND

In recent years, in security equipment in large-scale facilities such as airports and plants and facilities associated with lifelines such as power plants and waterworks, and a traffic information support system such as ITS, many systems, each of which tracks an object using, for example, an ITV camera to attain continuous monitoring and to acquire detailed information, have been commercialized. These systems assume vehicles, marine vehicles, and airplanes as platforms in addition to a ground equipped type, and suppress disturbances against vibrations and fluctuations by compact, vibration-proof structures. Furthermore, in order to track a plurality of objects in turn, it is important to increase the whirling speed of the sensor to direct it to an object within a short period of time.

Such moving object image tracking system largely depends on the performance of a camera sensor since it detects tracking errors of a target from the camera sensor. That is, when tracking errors upon capturing images of a target by the camera sensor fall outside a visual field, the system loses sight of the target. This happens because the camera sensor requires image processing for extracting tracking errors from captured images, and it is difficult to shorten image capturing intervals, that is, sampling times, thus causing a delay in tracking of a target.

For this reason, when the moving speed of a target increases, the target falls outside the visual field of the camera, and tracking may be disabled.

Such moving object image tracking system has to include two or more axes in a gimbal structure, so as track a target which moves in all directions. In biaxial gimbals, when an object passes through or near the zenith, an AZ axis has to be instantaneously rotated through 180°, and the target tracking performance largely depends on the driving characteristics of the AZ axis. Furthermore, it is easy to realize a driving control system of the gimbal by a high sampling performance, but since driving commands of the gimbals are generated based on tracking errors, a delay is always produced from a sampling timing of the camera sensor. For this reason, when the moving speed of the target becomes higher, if gimbal commands suffer a delay, the target may fall outside the visual field of the camera due to an insufficient driving power, depending on the motor performance.

A conventional image tracking system is controlled to stably capture the position of an object by limiting an image range to reduce arithmetic processing, upon recognition of the position of the object in an image.

Also, as a method of estimating a target position even when image information cannot be obtained from a target, a method of measuring the distance between the target and image tracking system by a distance measuring sensor, thereby estimating and correcting the target position has been proposed.

In such related art, in the method of limiting an image range to reduce the arithmetic processing, camera sampling performance can be improved, but the visual field of the camera is narrowed down instead, resulting in small target tracking error allowable amounts. For this reason, it is difficult to obtain a solution to the problem that when the moving speed of a target becomes higher, the target falls outside the visual field of the camera, and tracking fails.

In the method of measuring the distance between the target and image tracking system to estimate the position of the target, the distance measuring sensor is required, which increases a cost for an image tracking system which does not include any distance measuring sensor. Furthermore, as the estimation precision of the target position depends on the distance measuring precision, a distance measuring sensor with very high precision is required to obtain a sufficiently high tracking performance.

### BRIEF DESCRIPTION OF THE DRAWINGS

FIG. 1 is a block diagram showing a moving object image tracking apparatus according to an embodiment;

FIG. 2 is an exemplary view showing a gimbal mechanism shown in FIG. 1;

FIG. 3 is a schematic block diagram showing a correction control system of the moving object image tracking apparatus shown in FIG. 1;

FIG. 4 is an exemplary view showing tracking errors between a camera visual field and a moving object according to the embodiment;

FIG. 5A is an exemplary view showing an overview of the trajectory of a target and that of a visual axis;

FIG. 5B is an exemplary view showing the relationship among the target, a visual axis vector, and a target position vector;

FIG. 6 is an enlarged view of the camera visual field from the zenith on a two-dimensional plane;

FIG. 7 is an exemplary view showing the relationship between the camera visual field which is enlarged more than FIG. 6, and respective vectors; and

FIG. 8 is an exemplary view showing the relationship between tracking errors from a camera and corrected tracking errors by a corrected tracking error calculator.

### DETAILED DESCRIPTION

In general, according to one embodiment, a moving object image tracking apparatus includes two drivers, a camera sensor, a tracking error detector, angle sensors, angular velocity sensors, a first calculator, a second calculator, a corrected tracking error detector, a generator, and a controller. The two drivers are respectively connected to an azimuth axis which is directed in a vertical direction and is supported to be free to rotate, and an elevation axis which is arranged in a horizontal direction perpendicular to the vertical direction, is supported to be free to rotate, and is rotatable from a front side of the horizontal direction toward a zenith, and individually drive to rotate the azimuth axis and the elevation axis. The camera sensor is supported by the elevation axis, and acquires image data by capturing an image of a moving object. The tracking error detector detects tracking errors as deviation amounts of the moving object from a visual field center from the image data as tracking error detection values. The angle sensors detect angles about the rotation axes for the respective drivers. The angular velocity sensors detect angular velocities about the rotation axes for the respective drivers. The first calculator calculates a position vector and a velocity vector of the moving object using the tracking error detection values and the angles. The second calculator calculates a visual axis vector of the camera sensor from the angles. The corrected tracking error detector calculates corrected tracking errors for each period shorter than a sampling period, the tracking error detection values being constant, from the velocity vector and a relationship between the visual axis vector and the position vector. The generator generates angular velocity command values required to drive the drivers to track the moving object using the corrected tracking errors. The controller controls the drivers so that differences between the angular velocity command values and the angular velocities become zero.

A moving object image tracking apparatus and method of this embodiment can provide a moving object image tracking apparatus which can reduce degradation of a tracking performance without adding any additional sensor.

A moving object image tracking apparatus according to an embodiment will be described in detail hereinafter with reference to the drawings. Note that in the following embodiments, the same reference numerals denote portions which perform the same operations, and a repetitive description thereof will be avoided.

In the moving object image tracking apparatus of this embodiment, a control system of a moving object image tracking mechanism is applied to an image tracking system.

### First Embodiment

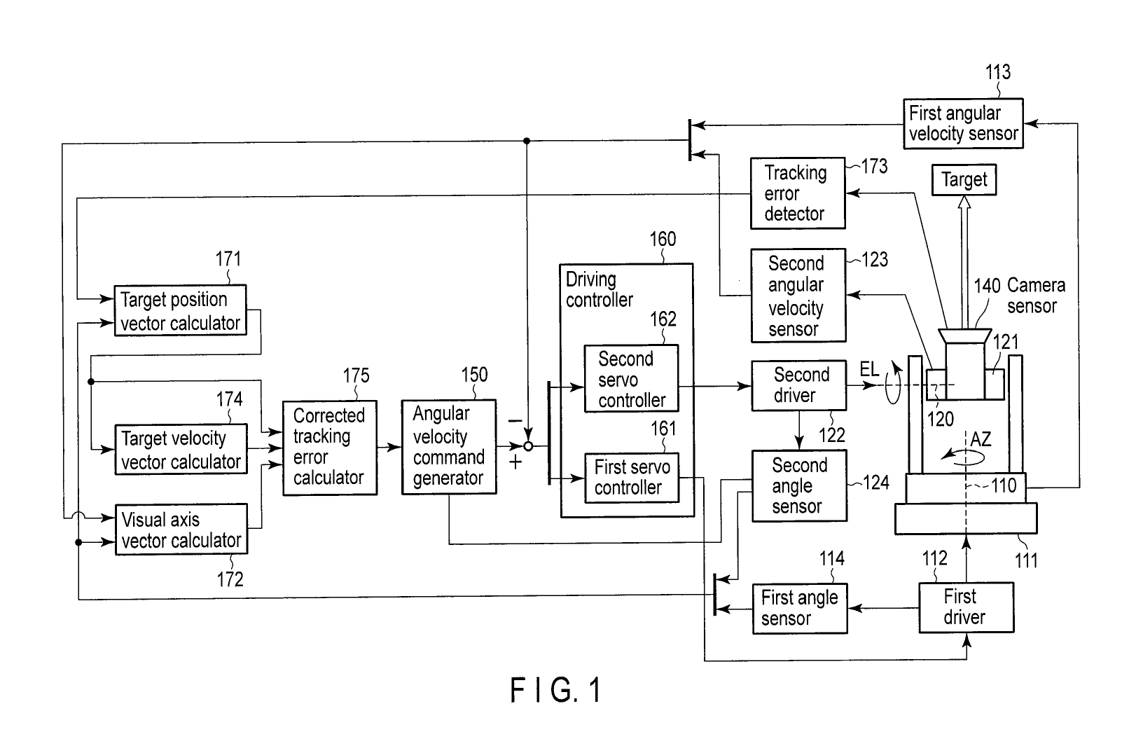

The moving object image tracking apparatus of this embodiment will be described below with reference to FIG. 1. The moving object image tracking apparatus of this embodiment includes first and second gimbals 111 and 121, first and second drivers 112 and 122, first and second angular velocity sensors 113 and 123, first and second angle sensors 114 and 124, a camera sensor 140, an angular velocity command generator 150, a driving controller 160, a target position vector calculator 171, a visual axis vector calculator 172, a tracking error detector 173, a target velocity vector calculator 174, and a corrected tracking error calculator 175. The driving controller 160 includes first and second servo controllers 161 and 162.

The first gimbal 111 is rotated about a first gimbal axis as an azimuth axis 110, which is directed in the vertical direction, and is supported to be free to rotate. The second gimbal 121 is rotated about a second gimbal axis as an elevation axis 120, which is arranged in the horizontal direction perpendicular to the azimuth axis, and is supported to be free to rotate.

The first and second drivers 112 and 122 drive to respectively rotate the first and second gimbals 111 and 121.

The first angular velocity sensor 113 detects the angular velocity of the first gimbal 111, which is rotated about the first gimbal axis. The second angular velocity sensor 124 detects the angular velocity of the second gimbal 121, which is rotated about the second gimbal axis.

The first angle sensor 114 detects the rotation angle of the first gimbal 111 with respect to a gimbal fixed portion. The second angle sensor 124 detects the rotation angle of the second gimbal 121 with respect to the first gimbal.

The camera sensor 140 is supported by the second gimbal 121, and recognizes a moving object to obtain image data.

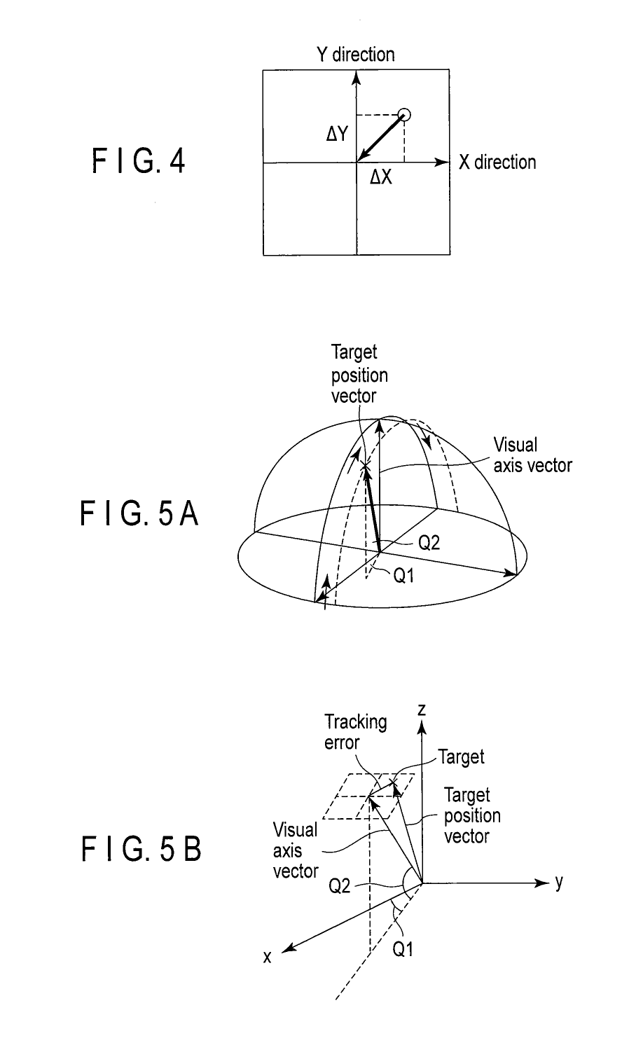

The tracking error detector 173 applies image processing to image data acquired from the camera sensor 140 to detect tracking error detection values. The tracking error detector 173 generally obtains a monochrome image by binarization, extracts feature points of a moving object to identify a position within a camera visual field, and detects deviation amounts (ΔX, ΔY) in two directions from the center of a visual field as tracking error detection values. A processing time period including these image processes corresponds to a sampling time period required to obtain the tracking error detection values. The tracking error detection values will be described later with reference to FIG. 4.

The target position vector calculator 171 receives the tracking error detection values in two directions acquired from the tracking error detector 173, and also the angles from the first and second angle sensors 114 and 124, thereby obtaining a position vector of a target viewed from a gimbal coordinate system (see FIG. 5B).

The target velocity vector calculator 174 receives the position vectors of the target acquired from the target position vector calculator 171, and obtains a velocity vector of the target from the time difference between the position vectors of the target.

The visual axis vector calculator 172 receives the angles from the first and second angle sensors 114 and 124, and obtains a visual axis vector of a camera included in each gimbal from a gimbal orientation. In order to correct delays of camera samples, the visual axis vector calculator 172 may receive angular velocities from the first and second angular velocity sensors 113 and 123 in addition to the angles, and may obtain a visual axis vector (see the second embodiment).

The corrected tracking error calculator 175 receives the target position vector acquired by the target position vector calculator 171, the target velocity vector acquired by the target velocity vector calculator 174, and the visual axis vector acquired by the visual axis vector calculator 172, and obtains tracking error detection values, which are corrected in consideration of a temporal change of a relative relationship between the target and camera.

The angular velocity command generator 150 generates angular velocity command values used to drive the gimbals to track the moving object (for example, using [equation 1] to be described later) based on the corrected tracking error detection values acquired from the corrected tracking error calculator 175 and an angle detection value η2 indicating a gimbal orientation detected by the second angle sensor 124. Details of this calculation will be described later with reference to FIG. 3.

The driving controller 160 calculates control command values to make differences between the angular velocity command values which are generated by the angular velocity command generator 150 and correspond to respective angular velocity sensors, and angular velocity detection values detected by the first and second angular velocity sensors 113 and 123 to be zero. The first and second servo controllers 161 and 162 respectively correspond to the first and second angular velocity sensors 113 and 123, and output control command values corresponding to the first and second drivers 112 and 122.

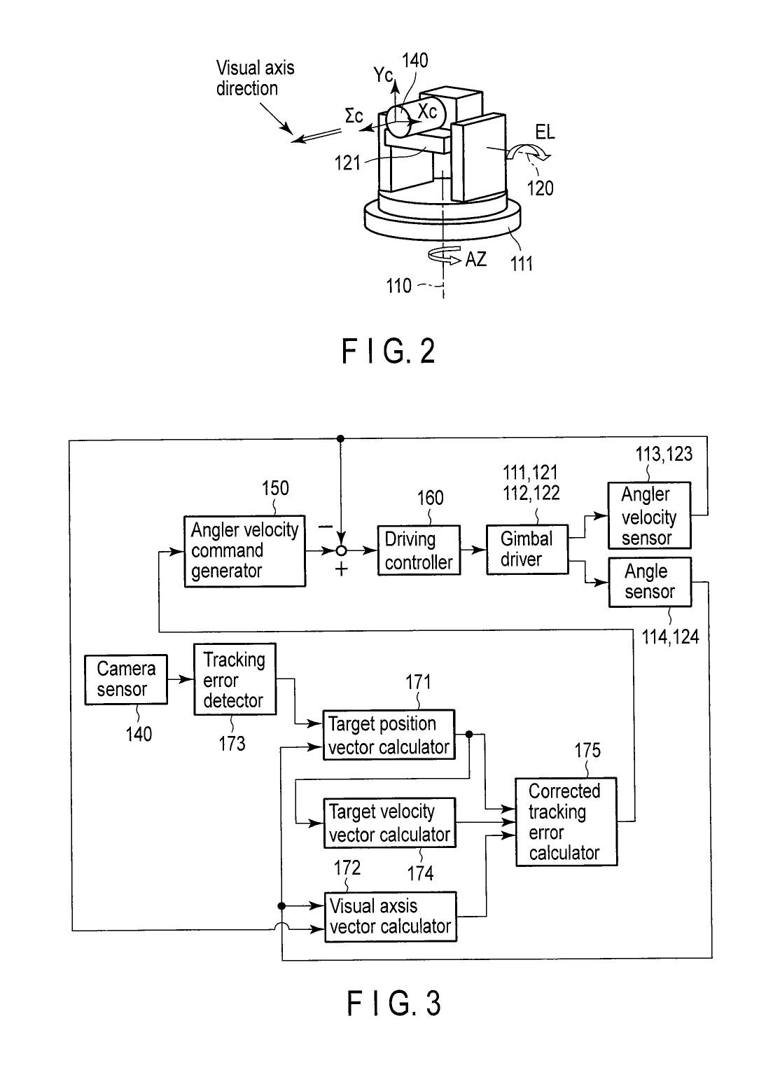

The gimbal mechanism used in this embodiment will be described below with reference to FIG. 2.

The first gimbal axis is the azimuth axis (to be simply referred to as “AZ axis” hereinafter), and the second gimbal axis is the elevation axis (to be simply referred to as “EL axis” hereinafter). The moving object image tracking apparatus shown in FIG. 1 is a biaxial rotary apparatus which includes a biaxial structure in which these AZ and EL axes cross each other at right angles at one point.

A correction control system of the moving object image tracking apparatus of this embodiment will be described below with reference to FIG. 3. FIG. 3 is a control block diagram which expresses two axes, that is, the AZ and EL axes, together.

The angular velocity command generator 150 generates the angular velocity command values required to drive the gimbals to track the target based on the tracking errors in two directions acquired from the tracking error detector 173, and angle detection values (θ1, θ2) of the two axes which are detected by the first and second angle sensors 114 and 124, and represent a gimbal orientation. The angular velocity command values are given by:

(\dot{θ}1,\dot{θ}2) (1)

As one of methods of distributing angular velocities to respective axes of the biaxial gimbals from the tracking error detection values (ΔX, ΔY) in two directions acquired from camera images, a relational expression of angular velocity command values with respect to tracking errors and angles is expressed by:

$$[ \begin{matrix}\dot{θ} r 1 \\ \dot{θ} r 2\end{matrix} ] = {K}_{c} [ \begin{matrix}- sec ( θ 2 ) & 0 \\ 0 & 1\end{matrix} ] [ \begin{matrix}Δ X \\ Δ Y\end{matrix} ] \qquad [ equation 1 ]$$

where K_{C} is the tracking gain. Also, secθ is a secant function associated with θ, which function becomes infinity when θ=90°. For this reason, a very large angular velocity command is generated for the first gimbal at or near the zenith.

The control according to this embodiment is executed not directly based on the tracking error detection values obtained from the camera sensor 140 but based on the target position vector calculator 171, target velocity vector calculator 174, and visual axis vector calculator 172, and the corrected tracking error detection values obtained from the corrected tracking error calculator 175, which uses values obtained from these calculators.

The visual field of an image acquired by the camera sensor, and moving object tracking will be described below with reference to FIG. 4.

FIG. 4 shows an overview of the visual field of a camera image, and moving object tracking according to this embodiment. When a target is captured within the camera visual field, the tracking error detection values (ΔX, ΔY) are obtained as deviation amounts from the camera center. Since a tracking delay is produced, these tracking error detection values are not allowable outside the camera visual field. The tracking error detection values desirably assume small values. However, even when the tracking error detection values assume large values, the target can be tracked by driving the biaxial gimbals as long as the tracking error detection value fall within the camera visual field.

The target position vector, target velocity vector, and visual axis vector will be described below with reference to FIGS. 5A, 5B, 6, and 7.

FIGS. 5A and 5B show an overview of the trajectory of a target and that of a visual axis. In a three-dimensional space, the visual axis can be directed in all the directions of a semi-spherical shape by the biaxial gimbals. Now, as a typical example, a case will be examined below wherein a target moves along positions separated away from the zenith from the front side to the back side. FIGS. 5A and 5B show a state in which the target is tracked to have gimbal orientation angles (θ1, θ2). This orientation forms a visual axis vector indicated by the bold line. By contrast, a target position vector is formed at the position of a mark x.

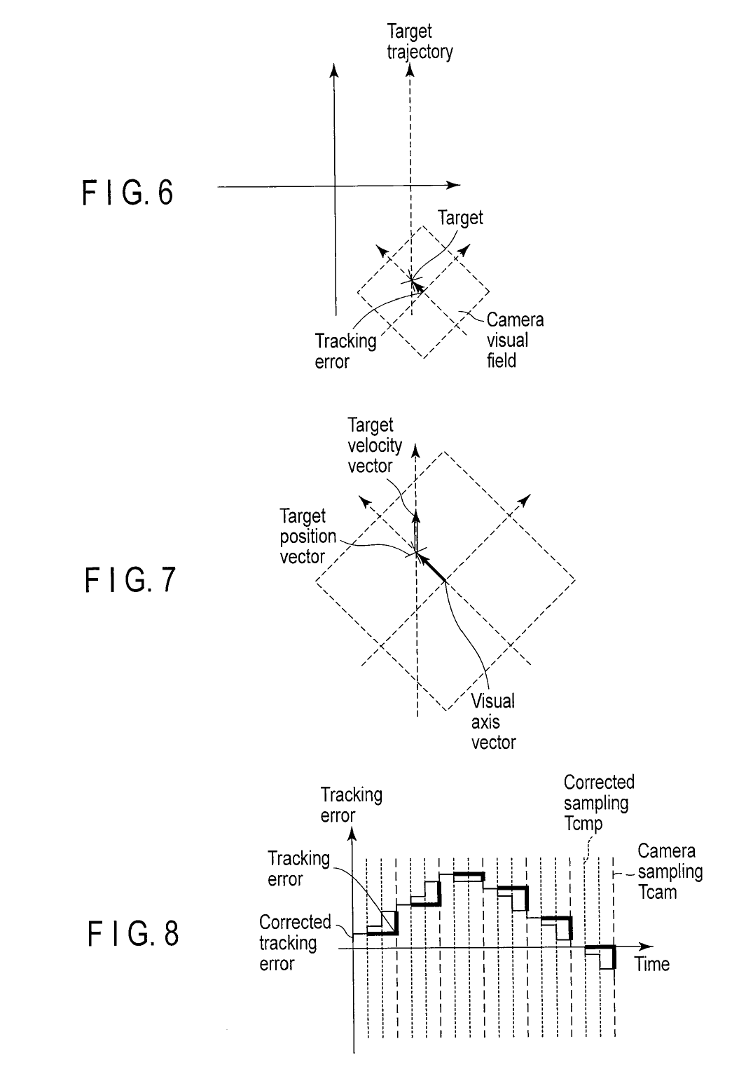

FIG. 6 is an enlarged view of a two-dimensional plane from the zenith direction. This example corresponds to a case in which the target moves from the lower side to the upper side. Upon tracking of the target, since gimbal angular velocity commands are generated from tracking errors, deviations from the target are always generated. For this reason, the target appears at a position deviated from the center with respect to the visual field formed to have the target visual axis vector as the center, thus generating tracking errors.

FIG. 7 is a further enlarged view of the camera visual field. FIG. 7 expresses the visual field as a two-dimensional plane, but a target position vector (eT_x, eT_y, eT_z) and target velocity vector (d_eT_x, d_eT_y, d_eT_z), and a unit vector (eE_x, eE_y, eE_z) of the visual axis vector, a unit vector (eX_x, eX_y, eX_z) of the horizontal direction of an on-gimbal camera, and a unit vector (eY_x, eY_y, eY_z) of the vertical direction of the on-gimbal camera are respectively three-dimensional vectors.

The target position vector calculator 171 calculates a target position vector eT viewed from the gimbal coordinate system from the tracking error detection values (ΔX, ΔY), and angle detection values (θ1, θ2) of the two axes, which represent the gimbal orientation. Note that the target position vector eT meets |eT|=1, and a target velocity vector d_eT meets |d_eT|=1.

Sines and cosines of the gimbals in the two axes are respectively expressed by:

C1=cos(θ1), S1=sin(θ1) C2=cos(θ2), S2=sin(θ2) [equation 2]

An inner product dot_eT_eE between the target position vector eT and a unit vector eE of the visual axis vector of the on-gimbal camera is expressed by:

dot_{—}eT_{—}eE={square root over (1/(1+ΔX²+ΔY²)} [equation 3]

An inner product dot_eT_eX between the target position vector eT and a unit vector eX of the horizontal direction of the on-gimbal camera is expressed by:

dot_{—}eT_{—}eX=ΔX·dot_{—}eT_{—}eE [equation 4]

Also, an inner product dot_eT_eY between the target position vector eT and a unit vector eY of the vertical direction of the on-gimbal camera is expressed by:

dot_{—}eT_{—}eY=ΔY·dot_{—}eT_{—}eE [equation 5]

From the relation among the inner products of these vectors, the target position vector eT (eT_x, eT_y, eT_z) is expressed by:

$$[ \begin{matrix}eT\_x \\ eT\_y \\ eT\_z\end{matrix} ] = [ \begin{matrix}- S 1 & - C 1 \cdot S 2 & C 1 \cdot C 2 \\ C 1 & - S 1 \cdot S 2 & S 1 \cdot C 2 \\ 0 & - C 2 & - S 2\end{matrix} ] [ \begin{matrix}dot\_eT \_eX \\ dot\_eT \_eY \\ dot\_eT \_eE\end{matrix} ] \qquad [ equation 6 ]$$

The target position vector calculator 171 calculates a target velocity vector d_eT from a time difference between the target position vectors obtained by the target position vector calculator. When the target position vectors are discretely obtained according to camera sampling timings, the target velocity vector d_eT is expressed from the difference between k-th and (k−1)-th samples, like:

$$[ \begin{matrix}d\_eT \_x \\ d\_eT \_y \\ d\_eT \_z\end{matrix} ] = [ \begin{matrix}eT\_x [ k ] - eT\_x [ k - 1 ] \\ eT\_y [ k ] - eT\_y [ k - 1 ] \\ eT\_z [ k ] - eT\_z [ k - 1 ]\end{matrix} ] \qquad [ equation 7 ]$$

Unlike this method, a method of calculating a target velocity vector using a Kalman filter is available. An example of this method will be described below.

The target velocity vector calculator calculates the target velocity vector d_eT by applying a time-varying Kalman filter to the target position vectors obtained by the target position vector calculator. As a general example, in consideration of a position x as an observable state quantity, and a velocity given by expression (2) below and an acceleration given by expression (3) below as state quantities that cannot be observed, a state variable is expressed by equation (4) below:

\dot{x} (2)

\ddot{x} (3)

$${x}_{k} = [ \begin{matrix}x \\ \dot{x} \\ \ddot{x}\end{matrix} ] \qquad ( 4 )$$

A discrete state equation with noise components w[n] and v[n] in association with this state variable is:

xₖ[n+1]=Aₖ*xₖ[n]+Bₖ·w[n]yᵥ[n]=Cₖ·x[n]+v[n] (5)

In this case, respective matrices are rewritten using a sampling time ΔT as:

$${A}_{k} = [ \begin{matrix}1 & Δ T & {( Δ T )}^{2} / 2 \\ 0 & 1 & Δ T \\ 0 & 0 & 1\end{matrix} ] , \\ {B}_{k} = [ \begin{matrix}{( Δ T )}^{3} / 6 \\ {( Δ T )}^{2} / 2 \\ Δ T\end{matrix} ] , \\ {C}_{k} = [ \begin{matrix}1 & 0 & 0\end{matrix} ] \qquad ( 6 )$$

Using a weight Q associated with a time transition of the Kalman filter and a weight R associated with an observed quantity, when an initial state quantity xₖ[0] and an initial error matrix Pₖ[0] are respectively expressed by:

$${x}_{k} [ 0 ] = [ \begin{matrix}0 \\ 0 \\ 0\end{matrix} ] , {P}_{k} [ 0 ] = {B}_{k} \cdot Q \cdot {B}_{k}^{T} \qquad ( 7 )$$

renewal rules of a Kalman gain M[n], state quantity xₖ[n], and error matrix Pₖ[n] are respectively expressed by:

m[n]=Pₖ[n]·Cₖ^{T}/(Cₖ·Pₖ[n]·Cₖ^{T}+R) xₖH=xₖ[n]+M[n]·(x−Cₖ·xₖ[n]) Pₖ[n]=(I−M[n]·Cₖ)·Pₖ[n] (8)

By contrast, renewal rules of time are expressed by:

xₖ[n+1]=Aₖ·xₖ[n]Pₖ[n+1]=Aₖ·Pₖ[n]·Aₖ^{T}+Bₖ·Q·Bₖ^{T} (9)

By solving these equations iteratively, state estimation can be attained by the Kalman filter. In the case of this embodiment, by applying the target position vector (eT_x, eT_y, eT_z) respectively in place of the position x as the observable state quantity in the general formula, the target velocity vector (d_eT_x, d_eT_y, d_eT_z) can be obtained. By applying the Kalman filter, the target velocity vector d_eT which is less influenced by noise can be obtained. The example of the method of calculating the target velocity vector using the Kalman filter has been described.

The description will revert to that with reference to FIG. 7.

The visual axis vector calculator 172 calculates a visual axis vector from the angle detection values (θ1, θ2) in the two axes. The unit vector (eE_x, eE_y, eE_z) of the visual axis direction of the on-gimbal camera is expressed by:

$$[ \begin{matrix}eE\_x \\ eE\_y \\ eE\_z\end{matrix} ] = [ \begin{matrix}C 1 \cdot C 2 \\ S 1 \cdot C 2 \\ - S 2\end{matrix} ] \qquad [ equation 8 ]$$

Also, the unit vector (eX_x, eX_y, eX_z) of the horizontal direction of the on-gimbal camera is expressed by:

$$[ \begin{matrix}eX\_x \\ eX\_y \\ eX\_z\end{matrix} ] = [ \begin{matrix}- S 1 \\ C 1 \\ 0\end{matrix} ] \qquad [ equation 9 ]$$

Furthermore, the unit vector (eY_x, eY_y, eY_z) of the vertical direction of the on-gimbal camera is expressed by:

$$[ \begin{matrix}eY\_x \\ eY\_y \\ eY\_z\end{matrix} ] = [ \begin{matrix}- C 1 \cdot S 2 \\ - S 1 \cdot S 2 \\ - C 2\end{matrix} ] \qquad [ equation 10 ]$$

The corrected tracking error calculator 175 calculates corrected tracking errors in consideration of a temporal change of a relative relationship between the target and camera from the target position vector (eT_x, eT_y, eT_z) obtained from the target position vector calculator 171, the target velocity vector (d_eT_x, d_eT_y, d_eT_z) obtained from the target velocity vector calculator 174, and the unit vector (eE_x, eE_y, eE_z) of the visual axis vector, the unit vector (eX_x, eX_y, eX_z) in the horizontal direction of the on-gimbal camera, and the unit vector (eY_x, eY_y, eY_z) of the vertical direction of the on-gimbal camera, which are obtained from the visual axis vector calculator 172.

From the relationship between the target position vector and visual axis vector, inner products (dot_eT_eE, dot_eT_eX, dot_eT_eY) of the respective vectors are expressed by:

$$[ \begin{matrix}dot\_eT \_eE \\ dot\_eT \_eX \\ dot\_eT \_eY\end{matrix} ] = [ \begin{matrix}eE\_x & eE\_y & eE\_z \\ eX\_x & eX\_y & eX\_z \\ eY\_x & eY\_y & eY\_z\end{matrix} ] [ \begin{matrix}eT\_x \\ eT\_y \\ eT\_z\end{matrix} ] \qquad [ equation 11 ]$$

This is the inverse transform of [equation 6]. Corrected tracking error detection values (ΔXr, ΔYr), which are re-calculated by inverse transformation from these inner products between the target position vector and visual axis vector, are expressed by:

ΔXr=dot_{—}eT_{—}eX/dot_{—}eT_{—}eE

ΔYr=dot_{—}eT_{—}eY/dot_{—}eT_{—}eE

The driving controller 160 calculates control command values, so as to make differences between the angular velocity command values, which are calculated according to [equation 1] by substituting ΔXr in ΔX and ΔYr in ΔY, and the angular velocity detection values detected by the first and second angular velocity sensors to be zero, and the gimbal mechanism is driven to track the moving object according the control command values. In this case, the gimbal mechanism includes the first and second gimbals 111 and 121, and the first and second drivers 112 and 122.

Interpolations between camera sample points according to this embodiment will be described below with reference to FIG. 8. FIG. 8 shows the relationship between the tracking errors from the camera and the corrected tracking errors by the corrected tracking error calculator 175.

The value of each of tracking errors obtained from the camera at intervals Tcam as camera sampling intervals indicated by the bold broken lines is held between neighboring sampling points. In order to improve the tracking characteristics, generation cycles of angular velocity commands of the gimbals are desirably quickened (shortened). Hence, in FIG. 8, for example, a case will be examined wherein corrected tracking errors are calculated at interpolated sampling intervals Tcmp of thin broken lines, which are ⅓ of the camera sampling cycles. Since the tracking errors can be obtained at the intervals Tcam, the target position vectors can be calculated at the same intervals. In order to interpolate between sample points, since the gimbal angles can be acquired at interpolated sampling timings earlier than the camera sampling timings, the visual axis vector calculator 172 according to this embodiment acquires the gimbal angle detection values at the intervals Tcmp, and calculates the visual axis vectors. Conversely to this visual axis vector, since an actual target has moved by an interval Tcmp from the camera sampling acquisition timing in the corrected tracking error calculator 175, a target position vector (eT_xr, eT_yr, eT_zr) corresponding to acquisition of the gimbal angle detection values can be expressed by linear interpolations according to the number n of interpolated samples (n=0 to 2 at the ⅓ cycles in this example) from the camera sampling acquisition timing, like:

$$[ \begin{matrix}eT\_xr \\ eT\_yr \\ eT\_zr\end{matrix} ] = [ \begin{matrix}eT\_x \\ eT\_y \\ eT\_z\end{matrix} ] + [ \begin{matrix}d\_eT \_x \\ d\_eT \_y \\ d\_eT \_z\end{matrix} ] \cdot Tcmp \cdot n \qquad [ equation 13 ]$$

Using the target position vector (eT_xr, eT_yr, eT_zr) corresponding to acquisition of the gimbal angle detection values, which vector is calculated in this way, the corrected tracking error calculator 175 calculates corrected tracking errors according to [equation 11] and [equations 12].

According to the aforementioned first embodiment, the state quantity of the target is updated at the camera sampling cycles, and the gimbal angle detection values are acquired at interpolated sampling cycles earlier than the camera sampling cycles, thereby updating the orientation vectors. Since the state quantity of the target is linearly interpolated according to the interpolated sampling cycles, tracking errors decided based on the relative relationship between the target and camera can be calculated by interpolation corrections. Hence, since the tracking errors can be obtained at cycles earlier than the camera sampling cycles, an effect of improving the target tracking characteristics can be obtained.

### Second Embodiment

This embodiment will explain correction processing of a camera sample delay, which is executed by a moving object image tracking apparatus.

The moving object image tracking apparatus acquires tracking errors via image processing applied to images from a camera. For this reason, a delay is produced due to, for example, the image processing and signal transmission until tracking errors are acquired. In order to improve tracking characteristics, it is desired to eliminate the influence of this delay. Since this delay time period is fixed for each apparatus, it can be recognized in advance. Letting Tdly be the delay time period, a gimbal orientation in real time has moved by this delay time period. Hence, a visual axis vector calculator 172 according to this embodiment expresses, using gimbal angle detection values (θ1, θ2) and gimbal angular velocity detection values given by expression (10) below, sines and cosines of gimbals for two axes by [equations 14] below.

(\dot{θ}1,\dot{θ}2) (10)

C1=cos(θ1+\dot{θ}1·Tdly), S1=sin(θ1+\dot{θ}1·Tdly) C2=cos(θ2+\dot{θ}2·Tdly), S2=sin(θ2+\dot{θ}2·Tdly) [equation 14]

Using the sines and cosines calculated in this way, visual axis vectors are calculated by [equation 8], [equation 9], and [equation 10]. For these visual axis vectors, a corrected tracking error calculator 175 can express a target position vector (eT_xr, eT_yr, eT_zr) corresponding to a delay by:

$$[ \begin{matrix}eT\_xr \\ eT\_yr \\ eT\_zr\end{matrix} ] = [ \begin{matrix}eT\_x \\ eT\_y \\ eT\_z\end{matrix} ] + [ \begin{matrix}d\_eT \_x \\ d\_eT \_y \\ d\_eT \_z\end{matrix} ] \cdot Tdly \qquad [ equation 15 ]$$

Using the target position vector (eT_xr, eT_yr, eT_zr) which is calculated in this way and corresponds to acquisition of the gimbal angle detection values, the corrected tracking error calculator 175 calculates corrected tracking errors according to [equation 11] and [equations 12].

According to the aforementioned second embodiment, in consideration of a movement of a target and that of a visual axis corresponding to the delay time period, tracking errors, which are decided based on a relative relationship between the target and camera, can be corrected and calculated. Hence, since tracking errors which are less influenced by a delay can be obtained, an effect of improving the target tracking characteristics can be obtained.

### Third Embodiment

This embodiment will explain correction processing at the time of a camera tracking error detection failure, which processing is executed by a moving object image tracking apparatus.

When a target is captured within the visual field of the camera, tracking errors can be obtained. However, when the moving speed of the target increases or the moving direction changes during tracking, and when gimbals are rotated at high speed, the target may fall outside the visual field, and detection of tracking errors may then fail. When tracking errors cannot be acquired, a calculation of a target position vector in a target position vector calculator 171 cannot be made. Hence, in a corrected tracking error calculator 175 according to this embodiment, using a target position vector (eT_x0, eT_y0, eT_z0) and target velocity vector (d_eT_x0, d_eT_y0, d_eT_z0), which are held before a tracking error detection failure, a predicted target position vector (eT_xr, eT_yr, eT_zr) when the target falls outside the visual field can be expressed by linear interpolations according to the number l of interpolated samples since the sampling timing before a tracking error detection failure using:

$$[ \begin{matrix}eT\_xr \\ eT\_yr \\ eT\_zr\end{matrix} ] = [ \begin{matrix}eT\_x 0 \\ eT\_y 0 \\ eT\_z 0\end{matrix} ] + [ \begin{matrix}d\_eT \_x0 \\ d\_eT \_y0 \\ d\_eT \_z0\end{matrix} ] \cdot Tcam \cdot l \qquad ( 11 )$$

Using the target position vector (eT_xr, eT_yr, eT_zr) which is calculated in this way and corresponds to a tracking error detection failure, corrected tracking errors are calculated according to [equation 11] and [equations 12].

According to the aforementioned third embodiment, even when the target has moved to fall outside the visual field, tracking errors, which are decided based on a relative relationship between the target and camera, can be corrected and calculated in consideration of a movement of the target and that of the visual axis using state quantities of the target beforec a detection failure. Hence, since pseudo tracking errors can be obtained, an effect of increasing the probability that tracking of the target resumes can be obtained.

According to the moving object image tracking apparatus of at least one of the aforementioned embodiments, tracking errors can be obtained at a higher sampling rate than that of the camera by interpolating tracking errors between neighboring sample points according to the gimbal orientation with respect to the target position and velocity vectors, which are calculated at sampling timings of the camera, without adding any additional sensor, thus improving the tracking characteristics.

Since relative vectors of the target and gimbal orientation are advanced by the delay time period of camera processing using the target position and velocity vectors and pieces of gimbal angle information and angular velocity information, tracking errors free from any influence of the delay can be obtained, thus improving the tracking characteristics.

Furthermore, even when the target falls outside the visual field of the camera sensor, and updating of detection of tracking errors is stopped, predicted values of tracking errors can be obtained using the target position and velocity vectors obtained at the last update timing, and pieces of current gimbal angle information and angular velocity information, thus increasing the probability that the target falls within the visual field again.

Moreover, the moving object image tracking apparatus of this embodiment allows tracking even near the zenith of the biaxial gimbal structure in a moving object camera tracking apparatus of the gimbal structure, including a TV camera, camera seeker, or automatic measuring device. Hence, the moving object image tracking apparatus of this embodiment is effective for a tracking camera system mounted on a moving object.

Note that the moving object image tracking apparatus of this embodiment is not limited to the biaxial gimbal structure, but it is applicable to a gimbal structure having two or more axes. For example, it is easy to analogize that even a triaxial gimbal structure can similarly calculate corrected tracking errors.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving object image tracking apparatus comprising:
two drivers configured to be respectively connected to an azimuth axis which is directed in a vertical direction and is supported to be free to rotate, and an elevation axis which is arranged in a horizontal direction perpendicular to the vertical direction, is supported to be free to rotate, and is rotatable from a front side of the horizontal direction toward a zenith, and individually drive to rotate the azimuth axis and the elevation axis;
a camera sensor configured to be supported by the elevation axis, and acquire image data by capturing an image of a moving object;
a tracking error detector configured to detect tracking errors as deviation amounts of the moving object from a visual field center from the image data as tracking error detection values;
angle sensors configured to detect angles about the rotation axes for the respective drivers;
angular velocity sensors configured to detect angular velocities about the rotation axes for the respective drivers;
a first calculator configured to calculate a position vector and a velocity vector of the moving object using the tracking error detection values and the angles;
a second calculator configured to calculate a visual axis vector of the camera sensor from the angles;
a corrected tracking error detector configured to calculate corrected tracking errors for each period shorter than a sampling period, the tracking error detection values being constant, from the velocity vector and a relationship between the visual axis vector and the position vector;
a generator configured to generate angular velocity command values required to drive the drivers to track the moving object using the corrected tracking errors; and
a controller configured to control the drivers so that differences between the angular velocity command values and the angular velocities become zero.

2. The apparatus according to claim 1, wherein the corrected tracking error detector calculates an interpolated position vector by interpolating between sampling timings, at which the image data are acquired, from the position vector and the velocity vector of the moving object, and calculates interpolated tracking errors from the interpolated position vector and the visual axis vector calculated from the angles at a sampling interval shorter than an acquisition interval of the image data.

3. The apparatus according to claim 1, wherein when a delay time period is produced upon acquisition of image data, the corrected tracking error detector corrects the position vector of the moving object and the visual axis vector by the delay time period.

4. The apparatus according to claim 1, wherein when image data fails to be acquired at a sampling timing, the corrected tracking error detector calculates interpolated tracking errors from the position vector and the velocity vector updated at a sampling timing before that sampling timing, and the visual axis vector calculated from the angles.

5. A moving object image tracking method comprising:
preparing two drivers configured to be respectively connected to an azimuth axis which is directed in a vertical direction and is supported to be free to rotate, and an elevation axis which is arranged in a horizontal direction perpendicular to the vertical direction, is supported to be free to rotate, and is rotatable from a front side of the horizontal direction toward a zenith, and individually drive to rotate the azimuth axis and the elevation axis;
preparing a camera sensor configured to be supported by the elevation axis, and acquire image data by capturing an image of a moving object;
detecting tracking errors as deviation amounts of the moving object from a visual field center from the image data as tracking error detection values;
detecting angles about the rotation axes for the respective drivers;
detecting angular velocities about the rotation axes for the respective drivers;
calculating a position vector and a velocity vector of the moving object using the tracking error detection values and the angles;
calculating a visual axis vector of the camera sensor from the angles;
calculating corrected tracking errors for each period shorter than a sampling period, the tracking error detection values being constant, from the velocity vector and a relationship between the visual axis vector and the position vector;
generating angular velocity command values required to drive the drivers to track the moving object using the corrected tracking errors; and
controlling the drivers so that differences between the angular velocity command values and the angular velocities become zero.

6. The method according to claim 1, wherein the calculating the corrected tracking errors calculates an interpolated position vector by interpolating between sampling timings, at which the image data are acquired, from the position vector and the velocity vector of the moving object, and calculates interpolated tracking errors from the interpolated position vector and the visual axis vector calculated from the angles at a sampling interval shorter than an acquisition interval of the image data.

7. The method according to claim 1, wherein when a delay time period is produced upon acquisition of image data, the calculating the corrected tracking errors corrects the position vector of the moving object and the visual axis vector by the delay time period.

8. The method according to claim 1, wherein when image data fails to be acquired at a certain sampling timing, the calculating the corrected tracking errors calculates interpolated tracking errors from the position vector and the velocity vector updated at a sampling timing before that sampling timing, and the visual axis vector calculated from the angles.
